(19) United States
(12) Patent Application Publication
(10) Pub. No.: US 2006/0283081 A1
(43) Pub. Date: Dec. 21, 2006

(54) Adjustable hanger for a potted plant

(76) Inventor: Robert Killen, South Pasadena, CA (US)

Correspondence Address: GOLDSTEIN LAW OFFICES, P.C., 2071 CLOVE ROAD - 204, STATEN ISLAND, NY, 10304, US

(21) Appl. No.: 11/253,916

(22) Filed: Oct. 20, 2005

Related U.S. Application Data
(60) Provisional application No. 60/621,603, filed on Oct. 22, 2004.

(51) Int. Cl. A01G 9/02

(52) U.S. Cl. 47/67; 248/318

(57) ABSTRACT

An adjustable hanger for a potted plant, having a selectively extendable cord which is attachable to the potted plant and which allows a user to easily raise and lower the potted plant without the need for climbing upon a step ladder or a chair. The adjustable hanger has a housing that encloses a spring-loaded ratchet reel assembly having a ratchet reel, a pawl which selectively engages the ratchet reel, and a coiled spring which biases the ratchet reel assembly to a position wherein the cord is selectively wound around the reel. When the pawl selectively engages the ratchet reel, the reel is only able to rotate in a clockwise direction, thereby fixedly suspending the potted plant at an optimal display height.

### CROSS REFERENCES AND RELATED SUBJECT MATTER

This application is a continuation of provisional patent application Ser. No. 60/621,603, filed in the United States Patent Office on Oct. 22, 2004.

### BACKGROUND OF THE INVENTION

1. Field of the Invention

The invention generally relates to a device for suspending a potted plant at an elevated height, and in particular relates to an adjustable hanger for a potted plant, having a cord which selectively extends from a housing, wherein the cord is attachable to the potted plant and allows a user to easily raise and lower the potted plant without the need for climbing upon a stepladder or a chair.

2. Description of the Related Art

Many plants are grown and maintained in hanging flower pots. Most plants require periodic maintenance, including watering and trimming the plants. In the case of a hanging potted plant, watering and trimming the plant often requires a user to climb upon a stepladder or a chair in order to reach the potted plant. However, climbing upon a stepladder or a chair in order to reach a plant is inconvenient and may lead to accidents. Accordingly, there is a need for an adjustable hanger for a potted plant, having a cord which selectively extends from a housing, wherein the cord is attachable to the potted plant and allows a user to easily raise and lower the potted plant without the need for climbing upon a stepladder or a chair.

A variety of accessories are available for use in conjunction with a potted plant. While these accessories may be suitable for the particular purpose employed, or for general use, they would not be as suitable for the purposes of the present invention as disclosed hereafter.

### SUMMARY OF THE INVENTION

It is an object of the invention to provide an adjustable hanger that allows a user to easily raise and lower a potted plant without the need for climbing upon a stepladder or a chair. Accordingly, the adjustable hanger comprises a ratchet reel assembly that enables the user to selectively lower the potted plant upon a cord without the need for climbing upon a stepladder or a chair.

It is another object of the invention to provide an adjustable hanger having a cord that may be selectively retracted into a reel assembly housing as desired. Accordingly, the ratchet reel assembly has an associated coiled spring that biases the ratchet reel assembly to selectively wind the cord around the reel and thereby retract the cord within the housing.

It is yet another object of the invention to provide an adjustable hanger that may be used to fixedly suspend a potted plant at an elevated display position. Accordingly, the ratchet wheel assembly has a ratchet wheel having ratchet teeth, and has a pawl that selectively engages the ratchet teeth. When the pawl engages the ratchet teeth, the ratchet wheel is prevented from rotating in a direction that would further extend the cord from the housing, and thereby fixedly suspends the potted plant at an elevated display position.

Further objects of the invention will become apparent in the detailed description of the invention that follows.

The invention is an adjustable hanger for a potted plant, having a selectively extendable cord which is attachable to the potted plant and which allows a user to easily raise and lower the potted plant without the need for climbing upon a step ladder or a chair. The adjustable hanger has a housing that encloses a spring-loaded ratchet reel assembly having a ratchet reel, a pawl which selectively engages the ratchet reel, and a coiled spring which biases the ratchet reel assembly to a position wherein the cord is selectively wound around the reel. When the pawl selectively engages the ratchet reel, the reel is only able to rotate in a clockwise direction, thereby fixedly suspending the potted plant at an elevated display position.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a perspective view of an adjustable hanger in a storage position.

FIG. 2A is a plan view of the adjustable hanger as in FIG. 1, wherein portions of the housing have been broken away to illustrate a spring-loaded ratchet reel assembly contained therein.

FIG. 2B is a plan view of the adjustable hanger as in FIG. 2A, except after a cord has been fully extended from the housing.

FIG. 3A is an enlarged view of a portion of the ratchet reel assembly shown in FIG. 2A, wherein a knot at the free end of the cord has pushed the pawl out from engagement with the ratchet teeth.

FIG. 3B an enlarged view of a portion of the ratchet reel assembly shown in FIG. 2B, wherein a knot at the attached end of the cord has pushed the pawl into engagement with the ratchet teeth.

FIG. 4 is a front elevational view of the adjustable hanger, wherein a potted plant is suspended therefrom.

### DETAILED DESCRIPTION OF THE PREFERRED EMBODIMENTS

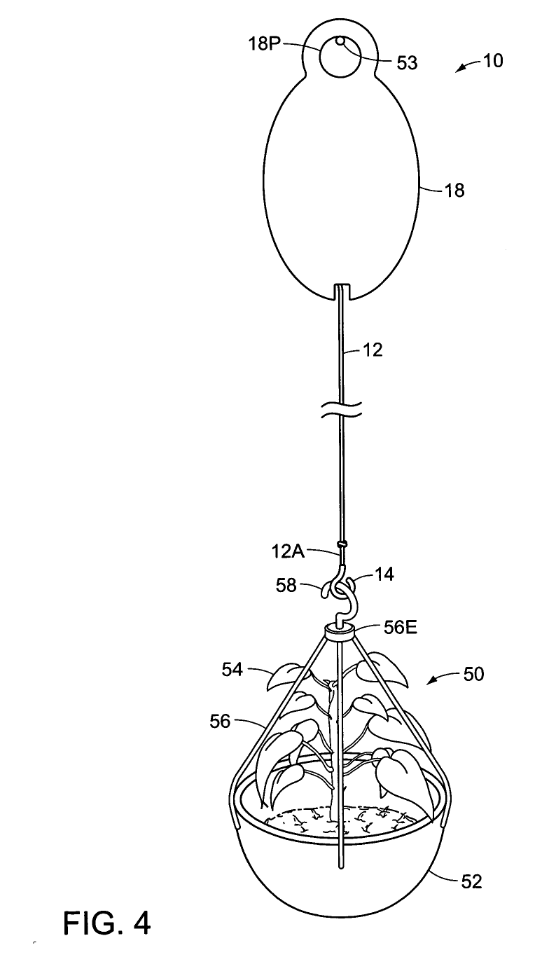

FIG. 4 illustrates an adjustable hanger 10, having a selectively extendable cord 12 having a free end 12A having a hook 14 attached thereunto. The adjustable hanger 10 has been attached to an existing vertical support structure with a nail 53, and is being used to suspend an existing potted plant 50 at a vertically elevated display height. The potted plant 50 comprises a pot 52 having cables 56 extending therefrom. The pot 52 contains a plant 54. The cables 56 have a hook 58 at their ends 56E, for selectively engaging the hook 14 at the free end 12A of the cord 12 of the adjustable hanger 10. In FIG. 4, the cord 12 has been substantially extended, and the hook 14 of the cord 12 selectively engages the hook 58 at the ends 56E of the cables 56 extending from the pot 52, as will be described.

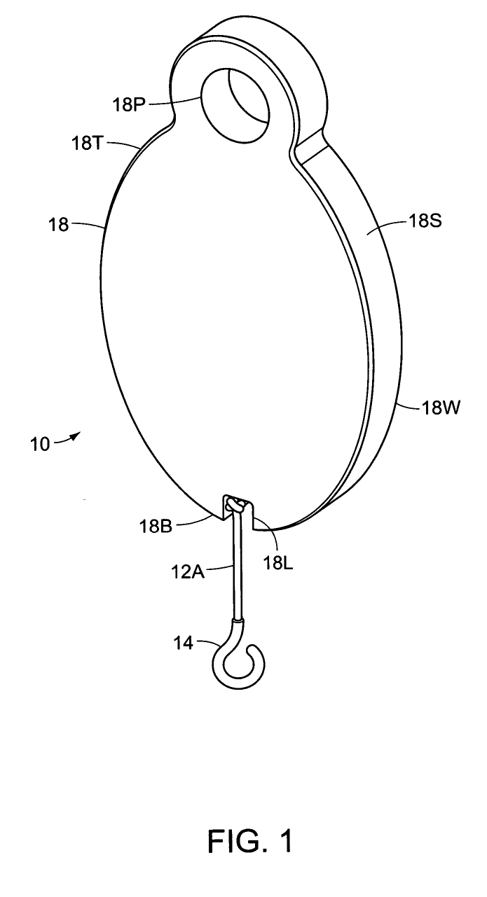

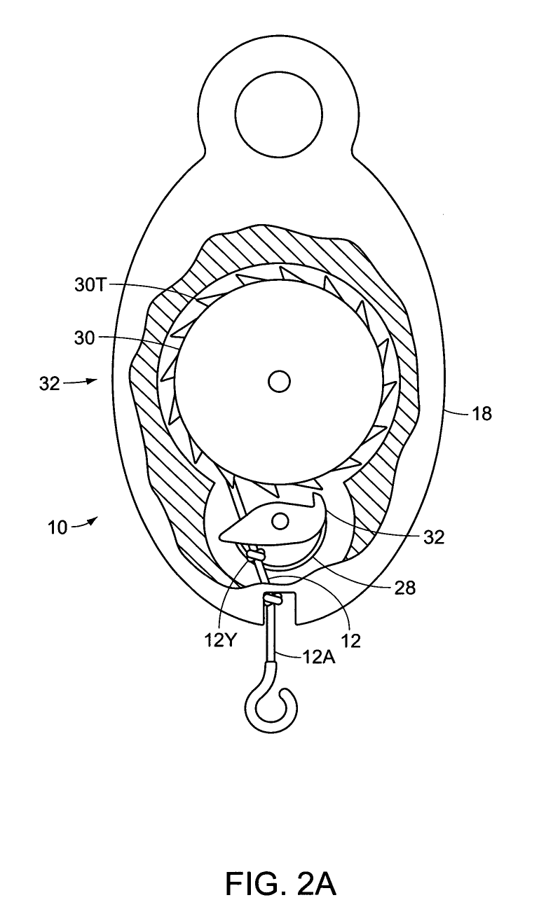

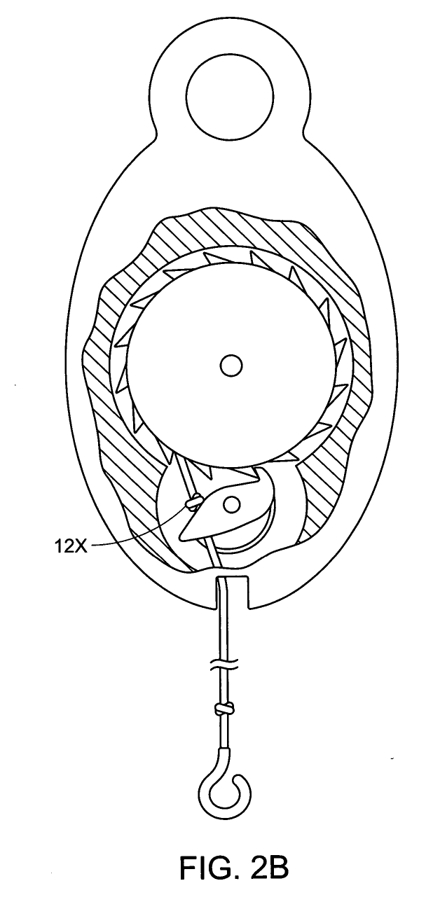

Turning to FIG. 1, the adjustable hanger 10 comprises a substantially hollow and oval housing 18, having a top 18T, a bottom 18B, two opposing sides 18S having a curved wall 18W extending therebetween, a circular opening 18P extending between the two opposing sides 18S in proximity to the top 18T, and a slot 18L in proximity to the bottom 18B through which the cord 12 selectively extends. Turning to FIG. 2A, the housing 18 contains a ratchet reel assembly 32 therein. The ratchet reel assembly 32 has a spring-loaded ratchet reel 30 having a plurality of ratchet teeth 30T, a pawl 32 for selectively engaging the ratchet teeth 30T, and a coiled spring 28 associated with the ratchet reel 30. The ratchet teeth 30T point in a clockwise direction.

The adjustable hanger 10 has a storage position wherein the cord 12 is selectively wound around the reel 30, and a deployed position wherein the cord 12 is partially or fully extended from the reel 30. FIG. 2A illustrates the adjustable hanger 10 in the equilibrium storage position, wherein the bias of the coiled spring 28 has caused the cord 12 to be selectively retracted within the housing 18 and fully wound around the reel 30, and wherein the pawl 32 is disengaged from the ratchet teeth 30T. Accordingly, the ratchet reel 30 is capable of rotation in both a clockwise direction and a counterclockwise direction. FIG. 2B illustrates a view wherein the cord 12 is substantially extended from the reel 30 and the pawl 32 is engaged with the ratchet teeth 30T.

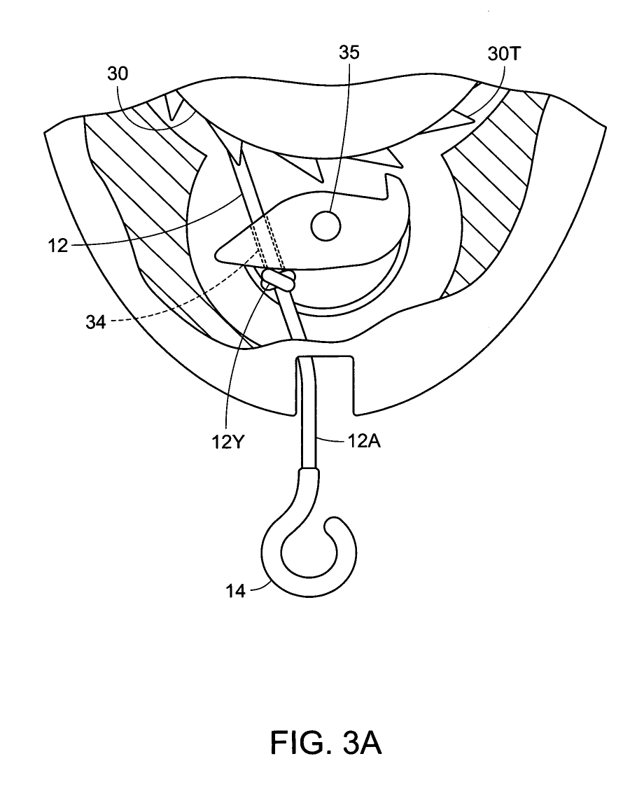

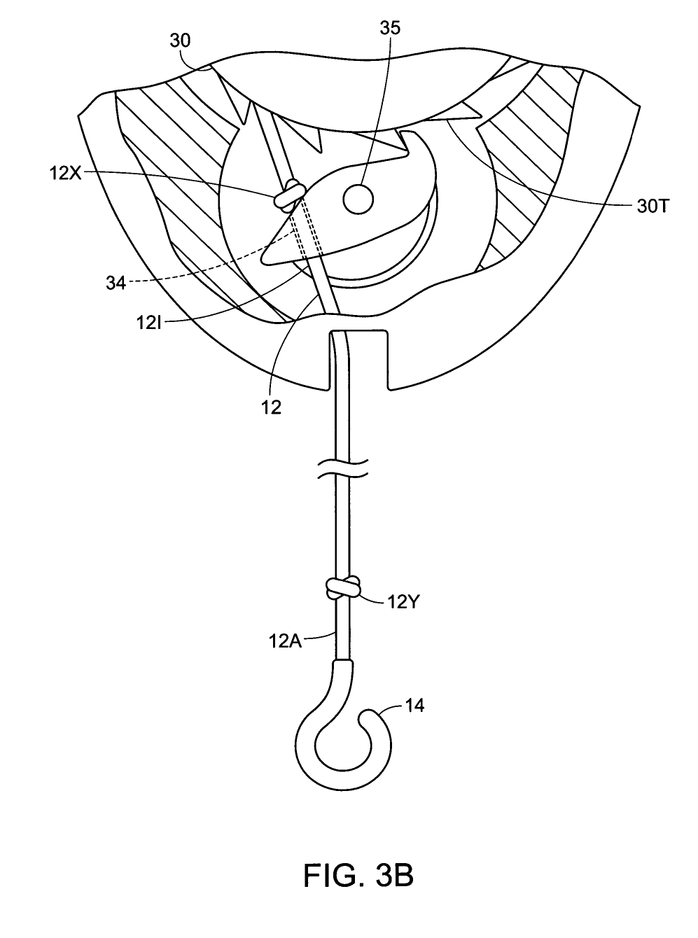

The mechanism by which the pawl 32 selectively engages the ratchet teeth 30T will now be described. FIG. 3A is an enlarged view of FIG. 2A. The cord 12 has an attached end that is anchored to the reel 30. The cord 12 has a knot 12X in proximity to the attached end 12B, and also has a knot 12Y in proximity to the free end 12A. The pawl 32 has a hollow cylindrical channel 34 having a diameter which is wide enough to allow the cord 12 to slide through unimpeded, but is narrow enough to prevent either of the knots, 12X or 12Y, from sliding through. The pawl 32 selectively swivels upon a hinge pin 35. The knot 12Y in proximity to the free end 12A has pushed the pawl 32 out from engagement with the ratchet teeth 30T, thereby allowing the ratchet reel 30 to rotate in either of two directions. Accordingly, after the user completely retracts the cord 12 into the housing 18, the user is able to extend the cord 12 out from the housing 18, because the ratchet reel 30 is able to rotate in a counterclockwise direction.

FIG. 3B is an enlarged view of FIG. 2B, wherein the cord 12 has been fully extended from the housing 18, and wherein the knot 12X in proximity to the attached end 12B has pushed against the pawl 32, thereby causing the pawl 32 to swivel into selective engagement with the ratchet teeth 30T. Accordingly, the ratchet reel 30 is no longer capable of rotation in two directions, but rather, is only capable of rotating in a clockwise direction.

The cord 12 is preferably constructed from a material such as plastic, elastic, or rubber. The housing 18 and the components of the ratchet reel assembly 32 are preferably constructed from a durable metal. The coiled spring 28 is preferably constructed from a resilient metal.

In use, the user attaches the adjustable hanger 10 onto an existing support structure such as a wall by extending a nail 53 or a threaded screw through the circular opening 18P of the housing 18 and into the support structure. The user attaches a potted plant 50 to the hook 14 at the free end 12A of the cord 12, and pulls the potted plant 50 fully downward, thereby fully extending the cord 12 from the reel assembly housing 18. This causes the knot 12X in proximity to the attached end 12B of the cord 12 to push the pawl 32 into engagement with the teeth 30T of the ratchet reel 30. Now, the ratchet reel 30 may only rotate in a clockwise direction, and the potted plant 50 may be selectively manually raised and stably maintained at an elevated display position. In order to lower the potted plant 50 for periodic maintenance, the user first manually lifts the potted plant 50 fully upwards, thereby allowing the bias of the spring 28 to fully retract the cord 12 back into the housing 18. This causes the knot 12Y at the free end 12A of the cord 12 to disengage the pawl 32 from the ratchet teeth 30T, thereby allowing the ratchet reel 30 to rotate in a counterclockwise direction, and thereby allowing the potted plant 50 to be fully lowered for servicing, and thereby causing the pawl 32 to once again reengage the ratchet teeth 30T. After servicing is complete, the user returns the potted plant 50 to the optimal display height by manually lifting the potted plant 50 to the optimal display height. The weight of the potted plant 50 prevents the cord 12 from being fully retracted within the housing 18 by the bias of the spring 28. If the user no longer desires to selectively adjust the vertical height at which the potted plant is suspended, the user may detach the potted plant 50 from the cord 12, remove the adjustable hanger 10 from the support structure, and store the adjustable hanger 10 until once again needed.

In conclusion, herein is presented an adjustable hanger for a potted plant, for allowing a user to easily raise and lower the potted plant without the need for climbing upon a stepladder or a chair. The invention is illustrated by example in the drawing figures, and throughout the written description. It should be understood that numerous variations are possible, while adhering to the inventive concept. Such variations are contemplated as being a part of the present invention.

What is claimed is:

1. An adjustable hanger for use by a user in conjunction with an existing potted plant and with an existing support structure, for allowing the user to easily raise and lower the potted plant without the need for climbing upon a stepladder, comprising:
a substantially hollow housing, having a top, a bottom, two opposing sides having a wall extending therebetween, an opening extending between the two opposing sides in proximity to the top, and a slot in proximity to the bottom;
a ratchet reel assembly contained within the housing, having a ratchet reel having a plurality of ratchet teeth, a pawl for selectively engaging the ratchet teeth, and a coiled spring associated with the ratchet reel; and
a cord having an attached end that is anchored to the reel, and having a free end which extends from the slot in proximity to the bottom of the housing, said free end having a hook upon which the potted plant may be selectively suspended, wherein the coiled spring causes the cord to be selectively retracted within the housing and fully wound around the reel, and wherein the cord may be selectively extended from the reel by the user pulling upon the cord; and
wherein upon selective complete retraction of the cord within the housing, the pawl disengages the ratchet teeth, and thereby allows the ratchet reel to rotate in either a clockwise direction or a counterclockwise direction, and wherein upon selective complete extension of the cord from the housing, the pawl engages the ratchet teeth, and thereby allows the ratchet reel to rotate only in a direction which allows the cord to be extended from the housing.

2. The adjustable hanger as recited in claim 1, wherein the cord has a knot in proximity to the attached end, and also has a knot in proximity to the free end, wherein the pawl has a hollow cylindrical channel having a diameter which is wide enough to allow the cord to slide through unimpeded, but is narrow enough to prevent either of the knots from sliding through, wherein the pawl selectively swivels upon a hinge pin, wherein upon selective and complete retraction of the cord into the housing, the knot in proximity to the free end pushes the pawl out from engagement with the ratchet teeth, thereby allowing the ratchet reel to rotate in either of two directions, and wherein upon selective and complete extension of the cord from the housing, the knot in proximity to the attached end pushes the pawl into selective engagement with the ratchet teeth, thereby allowing the ratchet reel to rotate only in a direction which allows the cord to be extended from the housing.

3. The adjustable hanger as recited in claim 2, wherein the cord is constructed from a material selected from a group of materials consisting of plastic, elastic, and rubber.

4. The adjustable hanger as recited in claim 3, wherein the coiled spring is constructed from a resilient metal.

5. The adjustable hanger as recited in claim 4, wherein the housing and the components of the ratchet reel assembly are constructed from a durable metal.

6. A method for allowing a user to easily raise and lower an existing potted plant to and from an optimal display height, without the need for climbing upon a stepladder, said method for use in conjunction with an existing support structure, said method utilizing an adjustable hanger having a housing, a ratchet reel assembly contained within the housing, said ratchet reel assembly having a ratchet reel having a plurality of ratchet teeth, a pawl for selectively engaging the ratchet teeth, and a coiled spring associated with the ratchet reel, said adjustable hanger further having a cord having an attached end that is anchored to the reel, and having a free end which extends from the housing, wherein the coiled spring causes the cord to be selectively retracted within the housing and fully wound around the reel, wherein the cord has a knot in proximity to the attached end, and also has a knot in proximity to the free end, said method comprising the steps of:
attaching the adjustable hanger to the support structure;
attaching the potted plant to the free end of the cord;
fully extending the cord from the housing, thereby causing the knot in proximity to the attached end of the cord to push the pawl into engagement with the ratchet teeth so that the ratchet reel may only rotate in a direction which causes the cord to be retracted within the housing;
manually raising the potted plant to the optimal display height;
stably maintaining the potted plant at the optimal display height because the ratchet reel is not able to rotate in a direction which would cause the cord to be further extended from the housing;
lowering the potted plant for periodic maintenance by first manually lifting the potted plant fully upwards, thereby allowing the bias of the spring to fully retract the cord into the housing, thereby causing the knot at the free end of the cord to disengage the pawl from the ratchet teeth so that the cord may be extended from the housing, thereby allowing the potted plant to be fully lowered to a position wherein the pawl re-engages the ratchet teeth; and
returning the potted plant to the optimal display height after maintenance is complete by manually lifting the potted plant to the optimal display height.

7. The method for raising and lowering an existing potted plant as recited in claim 6, wherein the step of attaching the adjustable hanger to the support structure comprises extending an existing nail through the opening of the housing and then into the support structure.
